(19) United States
(12) Patent Application Publication
(10) Pub. No.: US 2013/0339913 A1
(43) Pub. Date: Dec. 19, 2013

(54) Semi-automated method of FPGA timing closure

(71) Applicant: Evgeni Stavinov, San Jose, CA (US)

(72) Inventor: Evgeni Stavinov, San Jose, CA (US)

(21) Appl. No.: 13/523,887

(22) Filed: Jun. 15, 2012

(51) Int. Cl. G06F 17/50

(52) U.S. Cl. 716/104

(57) ABSTRACT

The invention describes a semi-automated method and system for Field Programmable Gate Array (FPGA) timing closure. The method is used to achieve timing closure by storing all previous results of design synthesis, place & route, tool options, and area constraints in a database, applying a set of analysis algorithms on the entire build history, and applying a decision engine to determine set of synthesis and place & route tool options and area constraints for the next build iteration. The aim of the inventive method is to eliminate most of the manual steps during design timing closure. The inventive method further makes the process faster, requiring fewer build iterations, and more robust to small design changes that can affect timing results. The desired outcome is achieved by making decisions based on the analysis of all the previous build results.

### FIELD OF THE INVENTION

The invention in general is related to electronic circuit timing closure and in particular to the semi-automated FPGA timing closure method.

### BACKGROUND OF THE INVENTION

Several types of Integrated Circuits (IC) are used in numerous electronic equipments today. The Field-Programmable Gate Array (FPGA) is a type of Integrated Circuits which is configurable by a customer. In a standard circuit design flow, timing closure relates to the ability to design a system or module that meets certain speed expectations without flaws being experienced in the behavior of the system. This means that a circuit designer can test a circuit during the design process to ensure that timing violations do not affect the operation of the circuit. An FPGA build process refers to a sequence of steps to build an FPGA design from a generic RTL design description and design constraints to a bit stream. The exact build sequence will differ, depending on the FPGA vendor. A typical FPGA build process includes the steps of synthesis, logic placement, logic routing, static timing analysis and bit stream generation. The physical implementation of an FPGA circuit contains the steps of Logic placement and routing.

The existing timing closure methods are slow and inefficient. They require multiple build iterations and significant amount of user interaction to perform routine tasks that can be automated by tools. Chang, et al. in the U.S. Pat. No. 7,149,992 describe a method for faster timing closure and better quality of results in Integrated Circuit physical design by using selective IPO procedure. The total number of critical paths after selective IPO is significantly reduced. However, the method works well with the timing violation potential and prioritizes the components and interconnects in a critical path using user input criteria. Another U.S. Pat. No. 6,457,164 by Hwang, et al. describes a method for determining the module placement in FPGAs using parametric modules with a plurality of floorplanning algorithms implementing the modules in row and column of elements. The U.S. Pat. No. 7,120,892 by Knol, et al. illustrates a floorplanner for IC design which employs an algorithm to fabricate the netlist of the FPGA. Murofushi in his U.S. Pat. No. 5,191,542 describes an automatic floorplan operation apparatus to automatically perform a layout of cells onto a plurality of arrangeable areas.

It is evident that current methodologies rely on the very last build results to determine tool options and area constraints for the next build, which is not suitable for many IC design processes. Also, the existing prior art disclose floorplanning methods which use automated tools or algorithms to design the floorplan for an FPGA use row and column methods to design the circuit.

### SUMMARY OF THE INVENTION

The invention discloses a method of designing an Integrated Circuit design having a plurality of logic modules for achieving a timing closure, the method comprising the steps of performing an initial design synthesis and place & route for the circuit to obtain initial build results, Adding the build results into a database, Using the database to perform analysis of the last and all previous build results, and Deciding on the next step based on the analysis results, Wherein, the timing closure of the Integrated Circuit design is achieved in a semi-automated manner.

The invention also discloses a system for designing an integrated circuit design for achieving a timing closure in a semi-automated manner, the system comprising a plurality of logic modules, a plurality of synthesis and place & route design tool options, a plurality of area constraint options to perform design floorplanning and a plurality of timing constraint options to specify design timing objectives.

### BRIEF DESCRIPTION OF DRAWINGS

FIG. 1 illustrates a process of FPGA building as a sequence of steps.

FIG. 2 illustrates a method of timing closure for FPGA circuits describes in prior art.

FIG. 3 illustrates the inventive method for FPGA timing closure according to an embodiment of the invention.

FIG. 4 illustrates an embodiment of the build database

FIG. 5 illustrates the relationship between logic and area constraints.

### DETAILED DESCRIPTION OF THE PREFERRED EMBODIMENTS

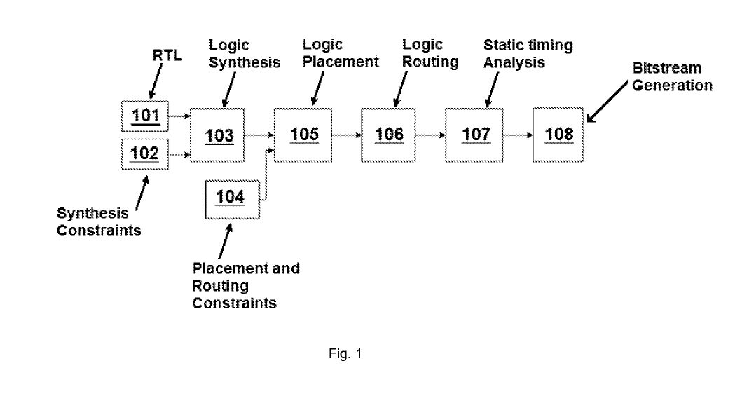

FIG. 1 shows a process of FPGA building as a sequence of steps carried out in the building of an FPGA circuit from a Register Transfer Level (RTL). A typical process of FPGA building includes an RTL 101, which is a level of abstraction used in describing the operation of a synchronous digital circuit. Another input apart from the RTL, is a set of synthesis constraints 102 that is fed into the logic of synthesis 103. In this process, placement and routing constraints play a major role in determining the actual floorplanning. In order to achieve a higher speed and timing closure, optimized routing and placement is necessary. Floorplanning a large, high speed design is the key to achieving timing closure. A good floorplanning can dramatically improve the design performance, and ensure consistent quality of the build results. Poor floorplanning can have an opposite effect, namely, making it impossible to meet timing constraints and cause inconsistent build results. Any of the floorplanning strategies involves specifying constraints in the form of placement and routing limitation. The logic placement 105 is a process of mapping a net-list to logic elements of a specific FPGA vendor and family. The next process is the logic routing 106 which is a process of adding interconnect routes between mapped logic elements. The static timing analysis 107 is done to ensure the timing closure for the routes given in the design constraints. After the design has been routed, it is needed to generate the binary data, which can be used to program the physical device. This is done with Bitstream Generation. The bit generation step 108 is the last step in the process of FPGA building process.

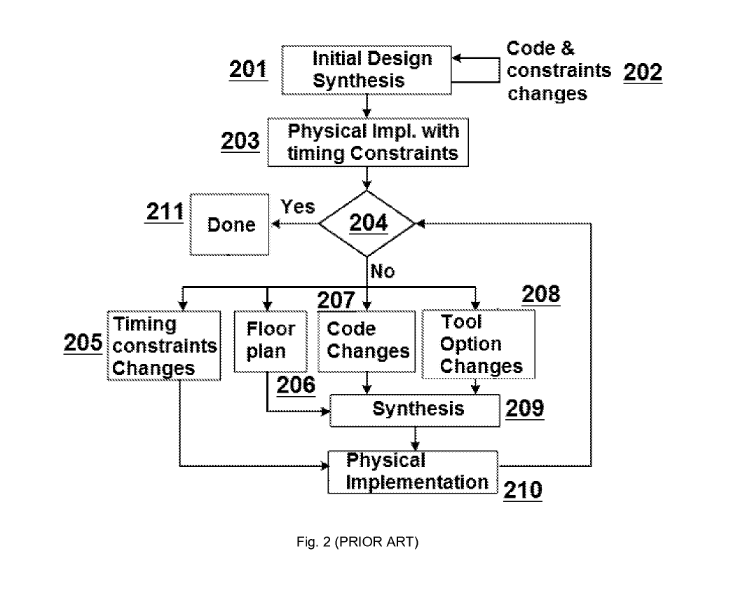

FIG. 2 illustrates a method of timing closure for FPGA circuits described in prior art. The initiation design synthesis and physical implementation of the circuit is conducted 201 and the timing constraints 203 are physically implemented. The step of design synthesis further implements the code and constraints changes as a feedback loop 202 to improve the design. The objective of the process is to achieve a required timing, which is decided by the designer. Unless the design meets the timing requirements, a variety of options are available at 204 to the designer which can be alerted to make the specific changes in the timing requirements. The timing constraint changes 205, area constraint or floorplanning changes 206, code changes 207 or tool option changes 208 can be performed to achieve the needed timing. Once these are achieved, the synthesis 209 and physical implementation 210 takes place. Here it is noteworthy that satisfactory changes in timing constraints at step 205 can directly lead to the physical implementation step 210, while the other three options lead to the synthesis and then physical implementation step.

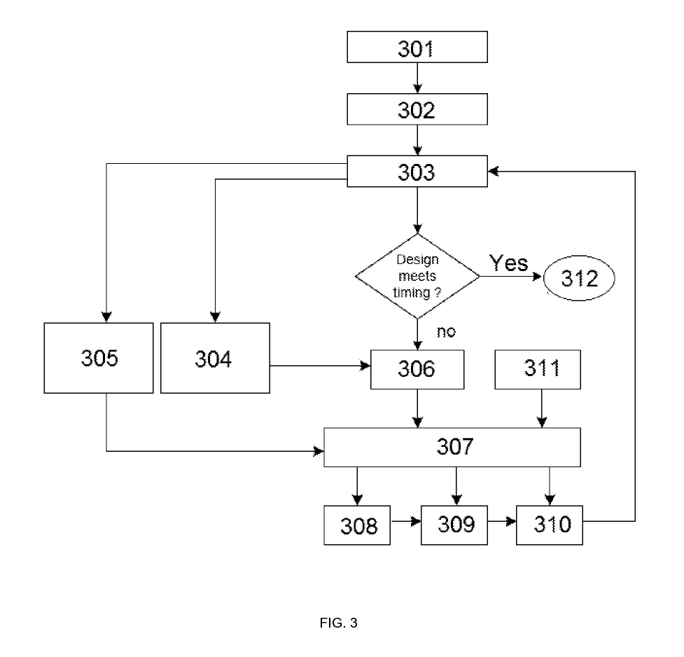

FIG. 3 illustrates the inventive method for FPGA timing closure. At the very first step of the process 301 the initial logic synthesis, which is netlist synthesis is carried out. At this stage of the semi-automated timing closure flow, the initial logic synthesis is performed on the original design using default synthesis tool options. After the initial synthesis, there is logic placement & routing step using default tool options and no area constraints at 302. The next step after the logic placement and routing is 303, which is to carry out static timing analysis of the circuit. Thereafter the build inputs and outputs are added to the build results database at 304. At this stage, the design is checked for the timing. If the design meets the timing closure requirements, the process is completed and the end of the process at 312 is called. However, if the design does not meet the timing, at step 306 the build analysis engine retrieves the results from all previous design builds, and performs processing of all builds stored in the database, analysis of placement differences, analysis of routing difference and Analysis of failing timing paths. Further, the above differences are correlated with the synthesis and place & route tool options, and design area constraints. Finally an analysis results database passed to the decision engine is created.

At step 304, the build inputs and outputs are added to the build results database. The inputs for each build comprise design source code, synthesis and place & route design tool options, design timing constraints, and design area constraints. Similarly, the output for each build comprises placement information, routing information and path that fail timing constraints. After step 303, another step 305 takes place which is to preserve the synthesized the netlist created after step 301 to a separate database. After this step, if the design meets the timing, the process is complete. Otherwise, at 307, the decision engine performs the following functions:
1. Receiving of initial set of decision rules and default values from the user at step 311; and
2. Receiving of analysis results database from analysis engine at step 306

The decision is then taken by the engine if the next step is automatically started synthesis, automatically started place & route, or it's required from a user to make manual changes to the design. In case the synthesis decision is taken, the determination of the range of tool options for the next build is done. In case the place & route decision is taken, the determination of the range of tool options and area constraints for the next place & round; and in case the manual changes occur, the system waits till user makes necessary changes to design source code.

At step 308 the process of manually making the RTL changes to the design takes place. The Decision engine at step 307 decides that design requires source code modification (a manual step). After the modification it is required to perform synthesis step 309 and place & route steps 310. At 309, the decision engine decides to change the synthesis tool option. After the change it is required to perform synthesis at step 309 and place & route steps 310, which are automatic processes. In the preferred embodiment, the synthesis tool options are vendor specific. However, most of the FPGA tool vendors support the options of Maximum fanout, register replication, Effort level, Seed, and Area and Speed optimization. At step 310 the Decision engine further decides that area constraints will be changed. After the change it is required to perform place & route step, which is automatic. Area constraints are vendor specific. However, most of the FPGA tool vendors support the following options:
1. X and Y coordinate of the rectangular region to constrain. XY coordinates determine shape, size, and the location of the region.
2. Constraint properties, for example, allowing unrelated logic inside the constrained region.
3. Determination of the list of logic modules to assign area constraints to. This is based on their size {min,max} range.
4. Determination of how many area constraints to assign to a specific logic module. It can be 1 or more.
5. Determination of the location of each area constraint based on the level of overlap, logic utilization percentage, connectivity between other logic modules with the area constraints.
6. Determination of the shape and size of each area constraint. This is based on the level of overlap, and logic utilization percentage.
7. Determination of area constraint properties.

At the next step, Decision engine decides that both place & route tool options and area constraints will be changed. After the change it is required to perform place & route step, which is automatic. The more build results accumulate in the database, the more accurately analysis and decision engines are able to decide on how to perform the next build iteration.

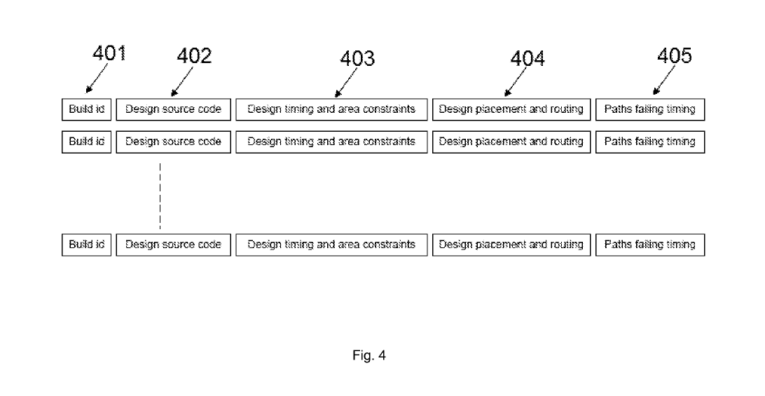

FIG. 4 illustrates the layout of the build results database which is formed by build inputs and outputs when they are added to the build results database. The inputs for each build comprise design source code, synthesis and place & route design tool options, design timing constraints, and design area constraints. Similarly, the output for each build comprises placement information, routing information tt and path that fail timing constraints. The database comprises the tables with the parameters of Build ID, Design Source Code, Design timing and area constraints, Design placement and routing; and Paths Failing time. A plurality of these building blocks of the database forms the build database.

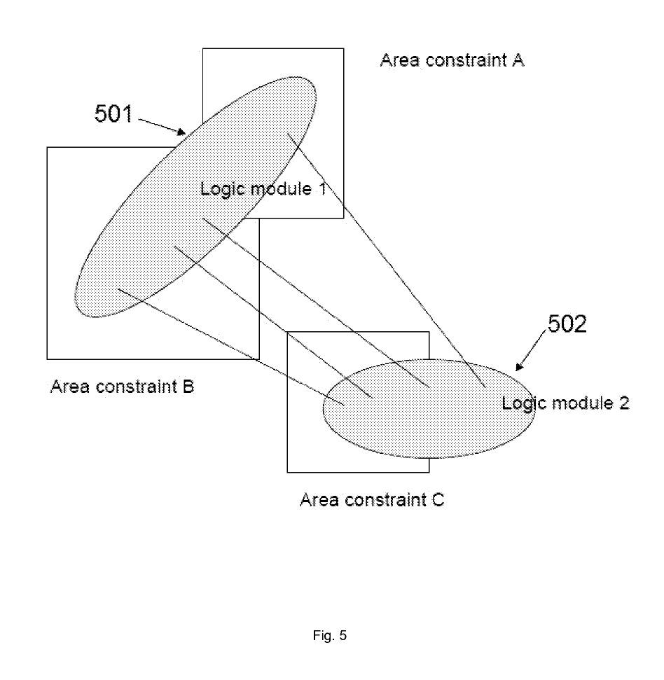

FIG. 5 illustrates the relationship between logic and area constraints. It depicts an example of logic placement of logic modules 501 and 502 after FPGA place & route. The placement is of irregular shape. There are three area constraints of rectangular shape applied to those two logic modules: a, b, and c. Also, there is a routing between logic modules 1 and 2. Those three area constraints are assigned by the decision engine such that:
1. Utilization is observed, that is the area constraints are at least as large as the underlying logic. Typically there is some margin added to it.
2. Overlap level between multiple area constraint rectangles is observed, such as between regions a and b.
3. Spatial relationship between multiple area constraints is intended to reduce routing delays between the logic modules. For example in FIG. 5, it's advantageous to locate area c as close as possible to areas a and b.

Although the present disclosure has been described with reference to particular illustrative embodiments, workers skilled in the art will recognize that changes may be made in form and detail without departing from the disclosure or the claims herein. As one illustrative example, components that may be described in a particular embodiment may be equivalently provided in one single integrated circuit chip, or with components distributed over two or more integrated circuit chips, or with various integrated circuit chips distributed over a computer motherboard or other circuit board, or with some or all elements distributed over other types of circuits, computing device elements, and other hardware and software resources. Many other variations among different embodiments may also be made within the bounds of the subject matter described by the present disclosure and defined by the claims recited below.

1. A method of designing an Integrated Circuit design having a plurality of logic modules for achieving a timing closure, the method comprising the steps of:
a. Performing an initial design synthesis and place & route for the circuit to obtain initial build results;
b. Adding the build results into a database;
c. Using the database to perform analysis of the last and all previous build results; and
d. Deciding on the next step based on the analysis results
Wherein, the timing closure of the Integrated Circuit design is achieved in a semi-automated manner.

2. The integrated circuit of claim 1 is a Field Programmable Gate Array.

3. The database of claim 1 comprises a list of builds.

4. The list of builds of claim 3, wherein each of the builds in the list comprises a plurality of inputs and a plurality of outputs.

5. The plurality of inputs of claim 4, wherein each of the plurality of inputs comprises:
a. A Design source code,
b. A set of synthesis, and place & route design tool options,
c. Design timing constraints, and
d. Design area constraints.

6. The plurality of outputs of claim 4, wherein each of the plurality of outputs comprises:
a. A Placement Information,
b. A routing information, and
c. A set of Paths that fail timing constraints.

7. The analysis of claim 1 is performed using an analysis engine.

8. The analysis engine of claim 7, further performs the steps of:
a. Processing all builds stored in the database,
b. Analyzing placement differences,
c. Analyzing routing difference, and
d. Analyzing failing timing paths.
wherein the analysis engine correlates the above differences with the set of synthesis and place & route tool options, and design area constraints.

9. The analysis engine of claim 7 further creates an analysis results database passed to the decision engine.

10. The decision engine of claim 9 further performs the following steps of:
a. Receiving initial set of decision rules and default values from the user,
b. Receiving analysis results database from analysis engine, and
c. Deciding if the next step is automatically started synthesis, automatically started place & route, or it is required from a user to make manual changes to the design.

11. The decision engine of claim 9, further determines the range of tool options for the next build, if the decision is synthesis.

12. The decision engine of claim 9, further determines the range of tool options and area constraints for the next place & round, if the decision is place and route.

13. The decision engine of claim 9, further waits till user makes necessary changes to design source code, if the decision is manually changes.

14. A system for designing an integrated circuit design for achieving a timing closure in a semi-automated manner, the system comprising:
a. a plurality of logic modules;
b. a plurality of synthesis and place & route design tool options;
c. a plurality of area constraint options to perform design floorplanning; and
d. a plurality of timing constraint options to specify design timing objectives.
